(19) United States
(12) Patent Application Publication
(10) Pub. No.: US 2010/0304338 A1
(43) Pub. Date: Dec. 2, 2010

(54) POLYMER IMPRESSION MATERIALS

(75) Inventors: Neil Cramer, Boulder, CO (US); Sheldon Newman, Centennial, CO (US); Tai Yeon Lee, Elgin, IL (US); Kathleen Schreck, Boulder, CO (US); Christopher N. Bowman, Boulder, CO (US); Cora B. Bracho-Troconis, Superior, CO (US)

Correspondence Address: MERCHANT & GOULD PC, P.O. BOX 2903, MINNEAPOLIS, MN, 55402-0903, US

(73) Assignee: The Regents of the University of Colorado, Denver, CO (US)

(21) Appl. No.: 12/678,801

(22) PCT Filed: Sep. 17, 2008
(86) PCT No.: PCT/US08/76639

§ 371 Date: Aug. 17, 2010

Related U.S. Application Data
(60) Provisional application No. 60/973,666, filed on Sep. 19, 2007.

(51) Int. Cl. A61C 9/00; A61C 13/08

(52) U.S. Cl. 433/202.1; 433/213; 433/214

(57) ABSTRACT

This invention relates to methods and compositions for single component photoinitiated dental impression materials. The impression material is workable in its pre-cured state, cures rapidly upon exposure to light, and exhibits desirable processing conditions such as short setting time, long working time, no void formation, good wettability, mechanical properties, and detail reproduction.

### CROSS-REFERENCES TO RELATED APPLICATIONS

This application is being filed on 17 Sep. 2008, as a PCT International Patent application in the name of THE REGENTS OF THE UNIVERSITY OF COLORADO, a U.S. national corporation, applicant for the designation of all countries except the U.S., and Neil Cramer, a citizen of the U.S., Sheldon Newman, a citizen of the U.S., TaiYeon Lee, a citizen of South Korea, Kathleen Schreck, a citizen of the U.S., Christopher N. Bowman, a citizen of the U.S., and Cora B. Bracho-Troconis, a citizen of France, applicants for the designation of the U.S. only, and claims priority to U.S. Provisional Patent Application Ser. No. 60/973,666 filed on 19 Sep. 2007.

### BACKGROUND OF THE INVENTION

An impression material is a substance used for making a negative reproduction or impression, such as of an object. The impression can then be used as a mold from which copies of the object can be made. Impression materials are used for a variety of applications. One example is the creation of artificial teeth and dentures.

Impression materials are used to record the shape of the teeth and alveolar ridges. There are a wide variety of impression materials available each with their own properties, advantages and disadvantages. Materials in common use can be classified as elastic or non-elastic according to the ability of the set material to be withdrawn over undercuts.

Elastic impression materials include aqueous colloids and non-aqueous elastomers. Aqueous colloids include agar and alginate. Although aqueous colloids are inexpensive, they show poor dimensional stability and can contract with time; conversely, swelling can occur due to water absorption, and the alginates tear easily.

Nonaqueous elastomers include polysulfide polymers, silicones and polyethers. Polysulfide polymer impression materials rely upon a polysulfide reaction by oxidation of a mercaptan with lead or copper dioxide to form polysulfide rubber, lead oxide and water. Preparation requires the mixing of two pastes. Although polysulfide is an inexpensive material with acceptable working time, high tear strength, good flexibility and good detail reproduction; disadvantages include long set time (8-12 minutes), poor dimensional stability, and bad odor.

Silicone impression materials include condensation silicones and addition silicones. Condensation silicones are comprised of polydimethylsiloxane, tetraorthosilicate and filler and polymerization is chemically catalyzed by a metal organic ester. Preparation requires the mixing of two pastes at the point of use. Condensation silicones are utilized in dual impression putty-wash techniques in order to reduce effect of polymerization shrinkage and ethanol by-product evaporation; however, they are clean and pleasant, have better elastic properties than the nonaqueous elastomers and have good working and setting times. Disadvantages include poor dimensional stability with high shrinkage due to polymerization and hydrophobicity resulting in poor wettability.

Addition silicone impression materials are also known as vinyl polysiloxanes (VPS). Commercially available VPS impression materials include President MonoBody (Coltene Whaledent, Alstatten, Switerland), Extrude® MPV (Kerr Corp., Orange, Calif.) and Aquasil (Dentsply Caulk, Milford, Del.). A first paste comprising a vinylpoly(dimethylsiloxane) prepolymer is mixed with a second siloxane prepolymer paste and a chloroplatinic acid catalyst. Preparation requires the mixing of two pastes at the point of use and exploits chemical-catalyzed polymerization. VPS impression materials have good accuracy, good dimensional stability and thus can accommodate multiple castes, and have a pleasant odor for good patient acceptability. Disadvantages of VPS impression materials include high cost; susceptibility to catalyst poisons which inhibit setting such as sulfur, latex gloves, and retraction solutions; short working time; lower tear strength; and possible hydrogen gas release which can cause bubbles on the die. In addition, generally a dry working environment is best due to initial hydrophobicity of VPS materials. Surfactants have been added to certain addition silicones to enhance hydrophilicity; however, the presence of surfactant can lead to voids and inaccurate impressions.

Polyether impression materials (e.g. Impregum™ Penta™, 3M ESPE, St. Paul, Minn.) offer better initial hydrophilicity in the unset stage than VPS materials. Polyethers comprise a difunctional epimine-terminated prepolymer with fillers and plasticizers and are catalyzed by aromatic sulfonic acid esters for cationic polymerization by ring opening and chain extension. Preparation requires the mixing of two pastes at the point of use. Polyethers are accurate, have good dimensional stability in a dry environment, good surface detail, allow multiple casts and have good wettability. Unfortunately, the enhanced hydrophilicity of polyethers after cure can lead to difficulty in removal of the caste impression from the mouth. Disadvantages can include lower tear strength, high cost, short working time, rigidity which makes it difficult to remove from undercuts, and absorption of water which results in lower dimensional stability. In addition, polyethers can be somewhat unpleasant to the patient.

Clearly, there is room for improvement in impression material compositions. An ideal impression material would require no mixing at the point of use, would have a long working time, a rapid setting time, good elasticity, good accuracy, good detail reproduction, good dimensional stability, be amenable to use with single-viscosity impression techniques, be non-toxic and non-irritating, be acceptable and pleasant to the patient, be compatible with other materials used for artificial tooth and denture compounds, be appropriately elastic to impart high tear strength, be resistant to permanent deformation; and be economical with a long shelf life. In addition, increased initial hydrophilicity as compared to current VPS materials would offer improved accuracy in a wet environment, while decreased hydrophilicity after cure as compared to current VPS and polyether materials would allow ease of removal from the oral cavity. Although a variety of commercial impression materials are currently available, no single material can claim all of these desired characteristics.

The present disclosure provides thiol-ene photopolymerizable impression materials with advantages over current commercially available impression materials including tailorable hydrophobicity, low glass transition temperature, low rubbery modulus, and complete conversions of both thiol and vinyl functional groups. In one embodiment, polysiloxane-based thiol-ene impression materials exhibit improved initial hydrophilicity, decreased equilibrium hydrophilicity, and superior mechanical properties as compared to currently available VPS materials (Extrude® MPV) in regard to elastic recovery and flexibility, and further exhibit good detail reproduction.

### SUMMARY OF THE INVENTION

This invention relates to methods and compositions for single component photoinitiated dental impression materials. The thiol-ene impression material is workable in its pre-cured state, cures rapidly upon exposure to light, and exhibits desirable processing conditions such as short setting time, long working time, no void formation, good wettability, mechanical properties, and detail reproduction.

In one embodiment, the disclosure provides a method for making a dental impression mold comprising the steps of exposing an area for implant; applying and positioning a photochemically curable impression material comprising a thiol monomer and a vinyl monomer to said exposed area; applying sufficient pressure to seat and mold the impression material in a desired size and shape; and curing the impression material using a light source to form the dental impression mold. In one aspect, the method utilizes an impression material which comprises a thiol monomer which is selected from a polysiloxane-based thiol monomer, an alkyl thiol, a thiol glycolate ester, and a thiol propionate ester. In a specific aspect, the method utilizes an impression material which comprises a thiol monomer which is a polysiloxane-based thiol monomer. In this aspect, the polysiloxane-based thiol monomer is formed from one or more silanes selected from mercaptopropyl methyl dimethoxysilane, phenylmethyldimethoxysilane, and diphenyldimethoxysilane. In another aspect, the method utilizes an impression material which comprises a vinyl monomer selected from a vinyl ether, vinyl ester, allyl ether, acrylate, methacrylate, norbornene, diene, propenyl, alkene, alkyne, N-vinyl amide, unsaturated ester, acrylate, N-substituted maleimide, polysiloxane-based vinyl monomer and a styrene.

In another embodiment, the method for making a dental impression mold utilizes a photochemically curable impression material further comprising one or more fillers. In one aspect, the one or more fillers are selected from one or more of silica, silicate glass, quartz, barium silicate, strontium silicate, barium borosilicate, strontium borosilicate, borosilicate, lithium silicate, lithium alumina silicate, amorphous silica, ammoniated or deammoniated calcium phosphate and alumina, zirconia, tin oxide, and titania. In one aspect, the amount of filler is from about 0 to about 25 wt % of the total weight of the dental impression material. In another aspect, the photochemically curable impression material further comprises one or more flavorants.

In a further embodiment, the disclosure provides a dental impression material composition, the composition comprising a thiol monomer and a vinyl monomer. In one aspect, the thiol monomer is selected from a polysiloxane-based thiol monomer, an alkyl thiol, a thiol glycolate ester, and a thiol propionate ester. In a specific aspect, the thiol monomer is a polysiloxane-based thiol monomer. In this aspect, the polysiloxane-based thiol monomer is prepared using one or more of mercaptopropyl methyl dimethoxysilane, (3-mercaptopropyl)methyl-methoxy-phenoxysilane, (3-mercaptopropyl)methyl-diphenoxysilane, (mercaptomethyl)methyldiethoxysilane, phenylmethyldimethoxysilane, and diphenyldimethoxysilane.

In another aspect, the vinyl monomer is a polysiloxane-based vinyl monomer. In a further aspect, the impression composition further comprises at least one photoinitiator. In a specific aspect, the photoinitiator is 2,2-dimethoxy-2-phenylacetophenone. In another aspect, the impression material composition further comprises a methacrylate.

In one embodiment, the impression material composition further comprises one or more fillers. In one aspect, the one or more fillers are selected from silica, silicate glass, quartz, barium silicate, strontium silicate, barium borosilicate, strontium borosilicate, borosilicate, lithium silicate, lithium alumina silicate, amorphous silica, ammoniated or deammoniated calcium phosphate and alumina, zirconia, tin oxide, and titania. In one aspect, the filler is silica.

In a specific aspect, the filler silica is a hydrophobic silica in a form selected from nanoparticles and nanoclusters. In another aspect, the impression material composition comprises one or more flavorants. In one aspect, the one or more flavorants are selected from peppermint oil, menthol, cinnamon oil, spearmint oil, vanilla, wintergreen oil, lemon oil, orange oil, grape, lime oil, grapefruit oil, apple, apricot essence, and mixtures thereof.

In another embodiment, the disclosure provides a method of making an artificial tooth comprising removing an amount of an impression material from a container, the impression material including a thiol monomer and a vinyl monomer; placing an amount of impression material in a mold tray; making an impression in the impression material, the impression having the desired shape of the artificial tooth; photopolymerizing the impression material to create a mold including a set impression of the artificial tooth; and creating at least one artificial tooth from the mold by placing an artificial tooth compound into the set impression and solidifying the artificial tooth compound. In one aspect, the method utilizes a thiol monomer which is selected from a polysiloxane-based thiol monomer, an alkyl thiol, a thiol glycolate ester, and a thiolpropionate ester.

### A BRIEF DESCRIPTION OF THE DRAWINGS

FIG. 1 shows chemical structures of silanes and vinyl ethers.

FIG. 2 shows chemical structure representations of polysiloxane-based thiol monomers synthesized in the examples.

FIG. 3 shows conversion versus time for polymerization of V4030/SiSH. Samples contain 0.2 wt % DMPA and are irradiated with 15 mW/cm² UV light with a 320-500 nm filter. Lines represent thiol and ene functional group conversion.

FIG. 4 shows conversion versus time for polymerization of V4030/SiSH MP/dimer acid (20 wt %). Samples contain 0.2 wt % DMPA and are irradiated with 15 mW/cm² UV light with a 320-500 nm filter. Lines represent vinyl ether and dimer acid functional group conversion.

FIG. 5 shows conversion versus time for polymerization of V4030/SiSH DP/dimer acid (40 wt %) Samples contain 0.2 wt % DMPA and are irradiated with 15 mW/cm² UV light with a 320-500 nm filter. Lines represent vinyl ether and dimer acid functional group conversion.

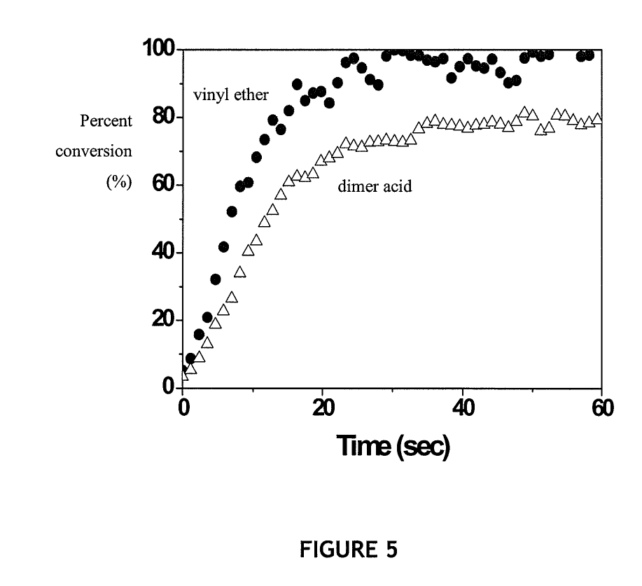

FIG. 6 shows contact angle (°) as a function of polysiloxane thiol content (wt %) of V4030/polysiloxane thiol mixtures. The values were measured within 5 seconds (□) and at 30 seconds (). Lines in figure represent values for the control sample (Extrude® MPV).

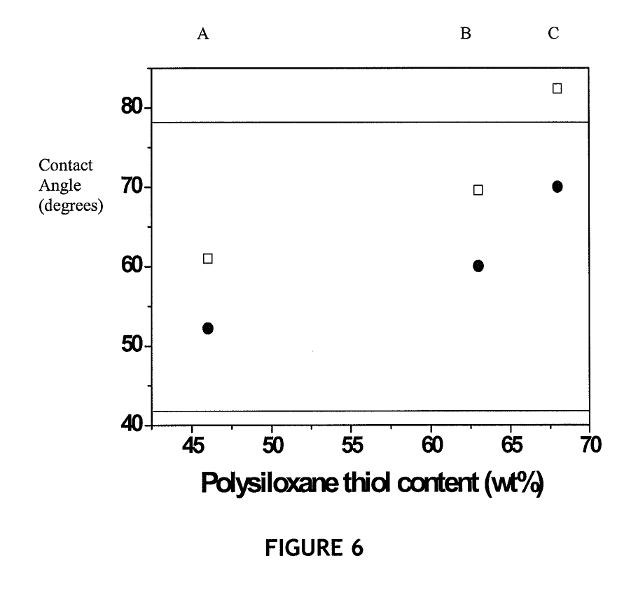

FIG. 7 shows surface profiles of V4030 SiSH DP filled with 10 wt % hydrophobic silica nanoparticles Aerosil R972 (top line) and the standard sample Extrude®MPV (bottom line). The Y-axis shows a height scale (μM) for stacked surface profiles.

### DETAILED DESCRIPTION

It is to be understood that the following detailed description is exemplary and explanatory and is intended to provide further explanation of the claimed invention.

The disclosure provides a new class of photocurable elastomeric dental impression materials utilizing thiol-ene photopolymerization techniques. The mechanism of thiol-ene free-radical photoinitiated polymerization is explained in a review article by Hoyle et al., Journal of Polymer Science Part-A. Polymer Chemistry 2004, 42, 5301, which is incorporated herein by reference. The photopolymerizable impression materials have advantages over current commercially available impression materials including tailorable hydrophobicity, low glass transition temperature, low rubbery modulus, and complete conversions of both thiol and vinyl functional groups. Another advantage of dental compositions comprising thiol-ene oligomers is a demonstrated lack of oxygen inhibition of polymerization (Hoyle et al., 2004).

The disclosure provides a thiol-ene impression material comprising a thiol monomer and a vinyl monomer. In certain embodiments, either one, or both, or neither, of the thiol monomer and the vinyl monomer may have a polysiloxane-based backbone. Therefore, the photopolymerizable impression material may be comprised of any combination of polysiloxane-based thiol monomers/oligomers, polysiloxane-based vinyl monomers/oligomers, thiol monomers/oligomers, and vinyl monomers/oligomers. Polysiloxanes are materials with high elasticity, flexibility, hydrophobicity, and good biocompatibility. Polysiloxane-based impression materials also exhibit high dimensional stability and detail reproduction.

As used herein, the following definitions shall apply unless otherwise indicated.

The term “aliphatic” or “aliphatic group” as used herein means a straight-chain or branched hydrocarbon chain that is completely saturated or that contains one or more units of unsaturation, or a monocyclic hydrocarbon or bicyclic hydrocarbon that is completely saturated or that contains one or more units of unsaturation, but which is not aromatic (also referred to herein as “carbocycle” or “cycloalkyl”), that has a single point of attachment to the rest of the molecule wherein any individual ring in said bicyclic ring system has 3-7 members.

For example, suitable aliphatic groups include, but are not limited to, linear or branched or alkyl, alkenyl, alkynyl groups and hybrids thereof such as (cycloalkyl)alkyl, (cycloalkenyl)alkyl or (cycloalkyl)alkenyl.

The terms “alkyl” and “alkoxy,” used alone or as part of a larger moiety include both straight and branched carbon chains. The terms “alkenyl” and “alkynyl” used alone or as part of a larger moiety shall include both straight and branched carbon chains.

The terms “haloalkyl,” “haloalkenyl” and “haloalkoxy” means alkyl, alkenyl or alkoxy, as the case may be, substituted with one or more halogen atoms. The term “halogen” or “halo” means F, Cl, Br or I.

The term “heteroatom” means nitrogen, oxygen, or sulfur and includes any oxidized form of nitrogen and sulfur, and the quaternized form of any basic nitrogen.

The terms “mercapto” or “thiol” refer to an —SH substituent, or are used to designate a compound having an —SH substituent.

The term “siloxane” refers to any chemical compound having a short repeating unit of silicon and oxygen atoms with organic side chains. The term “polysiloxane” refers to an extended siloxane repeat unit.

The term “aryl” used alone or in combination with other terms, refers to monocyclic, bicyclic or tricyclic carbocyclic ring systems having a total of five to fourteen ring members, wherein at least one ring in the system is aromatic and wherein each ring in the system contains 3 to 8 ring members. The term “aryl” may be used interchangeably with the term “aryl ring”.

The term “aralkyl” refers to an alkyl group substituted by an aryl. The term “aralkoxy” refers to an alkoxy group. The term “heterocycloalkyl,” “heterocycle,” “heterocyclyl” or “heterocyclic” as used herein means monocyclic, bicyclic or tricyclic ring systems having five to fourteen ring members in which one or more ring members is a heteroatom, wherein each ring in the system contains 3 to 7 ring members and is non-aromatic.

The term “thiol monomer” refers to any compound having a discrete chemical formula and having one or more thiol functional groups, or a reactive oligomer or reactive polymer or pre-polymer having at least one, but normally two or more, thiol groups. In one aspect, the thiol monomer may be selected from one or more of alkyl thiols, thiol glycolate esters, thiol propionate esters. In one aspect, the thiol monomer is selected from one or more of the group consisting of 2,5-dimercaptomethyl-1,4-dithiane, pentaerythritol tetramercaptoacetate, pentaerythritol tetramercaptopropionate, trimethylolpropane trimercaptoacetate, 2,3-dimercapto-1-propanol, 2-mercaptoethylsulfide, 2,3-(dimercaptoethylthio)-1-mercaptopropane, 1,2,3-trimercaptopropane, toluenedithiol, xylylenedithiol (Sigma-Aldrich, Milwaukee, Wis.); and trimethylolpropane tris(3-mercaptopropionate), and glycol dimercaptopropionate (Evans Chemetics LP, Iselin, N.J.).

In another aspect, the thiol monomer is a polysiloxane-based monomer. As used herein, a “polysiloxane based thiol monomer” includes any monomer having a discrete chemical formula and having one or more thiol functional groups, or a reactive oligomer or reactive polymer or pre-polymer having at least one, but normally two or more, thiol groups attached via an organic linker to a polysiloxane backbone.

In one embodiment, the polysiloxane-based thiol monomer is prepared from one or more mercaptoalkylsilanes. Mercaptosilanes suitable for this embodiment of the present invention include compounds having the formula Si(OR¹)(OR²)(R³)(R⁴—SH) wherein R¹, R² and R³ are independently selected from a C₁-C₁₂ aliphatic group or an aryl group and R⁴ is selected from a a C₁-C₁₂ aliphatic group. In a specific aspect, mercaptoalkylsilanes useful for the invention are, for example, 3-mercaptopropylmethyldimethoxysilane, (3-mercaptopropyl)methyl-methoxy-phenoxysilane, (3-mercaptopropyl)methyl-diphenoxysilane, and (mercaptomethyl)methyldiethoxysilane. In one aspect, one or more silanes with thiol functional groups are polymerized to form polysiloxane-based thiol monomers.

In another embodiment, the polysiloxane-based thiol monomer is prepared from one or more mercaptoalkylsilanes and one or more other silanes without thiol functional groups. Other silanes suitable for this embodiment of the present invention include alkoxysilane compounds having the formula Si(OR¹)₂(R²)(R³) wherein R¹, R² and R³ are independently selected from a C₁-C₁₂ aliphatic group or an aryl group. Specific examples of other silanes without thiol functional groups include diphenyldimethoxysilane (SiDP), phenylmethyldimethoxy silane (SiMP), and dimethyldimethoxysilane (SiDM). In one aspect, silanes with thiol functional groups are combined with one or more silanes without thiol functional groups and then polymerized to form polysiloxane-based thiol monomers.

Linear or branched polysiloxane monomers obtained from any organo-functional silane can be utilized for these impression material formulations. Impression materials with tunable mechanical properties and controlled hydrophobicities can be obtained by changing the silane functionality and/or making mixed oligomers of two or more different types of organo-silanes. Examples of relevant silanes include mercaptoalkylsilanes, alkoxy silanes and chlorosilanes containing an organic substituent possessing functionalities including (but not limited to) alkyl, amino, ether, ester, hydroxy, vinyl, and fluorinated moieties. Impression materials resulting from ene-functionalized polysiloxane oligomers with thiol-functionalized co-reactants are also suitable for use.

In one embodiment, the disclosure provides an impression material comprising a polysiloxane-based thiol monomer and a vinyl monomer which can be photopolymerized to obtain desired polymer characteristics. Such desired characteristics include reduced oxygen inhibition, fast polymerization, low polymerization-induced shrinkage, short setting time, long working time, no void formation, and good wettability and mechanical properties.

The impression material compositions of the disclosure comprise a thiol monomer and a vinyl monomer.

A “vinyl monomer” refers to any compound having a discrete chemical formula and having one or more vinyl functional groups, or a reactive oligomer, or reactive polymer, or pre-polymer, having at least one, but preferably two or more vinyl groups (i.e., any compound containing a C═C or a C≡C moiety). Vinyl functional groups can be selected from, for example, vinyl ether, vinyl ester, allyl ether, acrylate, methacrylate, norbornene, diene, propenyl, alkene, alkyne, N-vinyl amide, unsaturated ester, acrylate, N-substituted maleimides, and styrene moieties.

In one aspect, the vinyl monomer is a norbornene monomer. A “norbornene monomer” refers to any compound having a discrete chemical formula and having two or more norbornene pendent groups, or a reactive oligomer, or reactive polymer, or pre-polymer, having at least one, but preferably two or more norbornene groups. Suitable norbornene monomers included bis-2,2-[4-(2-[norborn-2-ene-5-carboxylate] ethoxy)phenyl]propane (BPAEDN), 1,6-hexanediol di-(endo,exo-norborn-2-ene-5-carboxylate) (HDDN), 2-((bicyclo[2.2.1]hept-5-enecarbonyloxy)methyl)-2-ethylpropane-1,3-diyl bis(bicyclo[2.2.1]hept-5-ene-2-carboxylate)(TMPTN), pentaerythritoltri-(norborn-2-ene-5-carboxylate) (PTN3), pentaerythritol tetra-(norborn-2-ene-5-carboxylate) (PTN4), tricyclodecane dimethanol di-(endo, exo-norborn-2-ene-5-carboxylate) (TCDMDN), and di(trimethylolpropane) tetra-(norborn-2-ene-5-carboxylate) (DTMPTN). These may be synthesized by the methods in Carioscia et al. J. Polymer Sci.: Part A: Polymer Chemistry 45, 5686-5696 (2007), “Thiol-norbornene materials: Approaches to develop high Tg thiol-ene polymers”, which is incorporated herein by reference. Certain other norbornene monomers may be prepared by the methods of Jacobine et al., 1992, Journal of Applied Polymer Science, 45(3), 471-485 “Photocrosslinked norbornene-thiol copolymers: Synthesis, mechanical properties, and cure studies”, which is incorporated herein by reference.

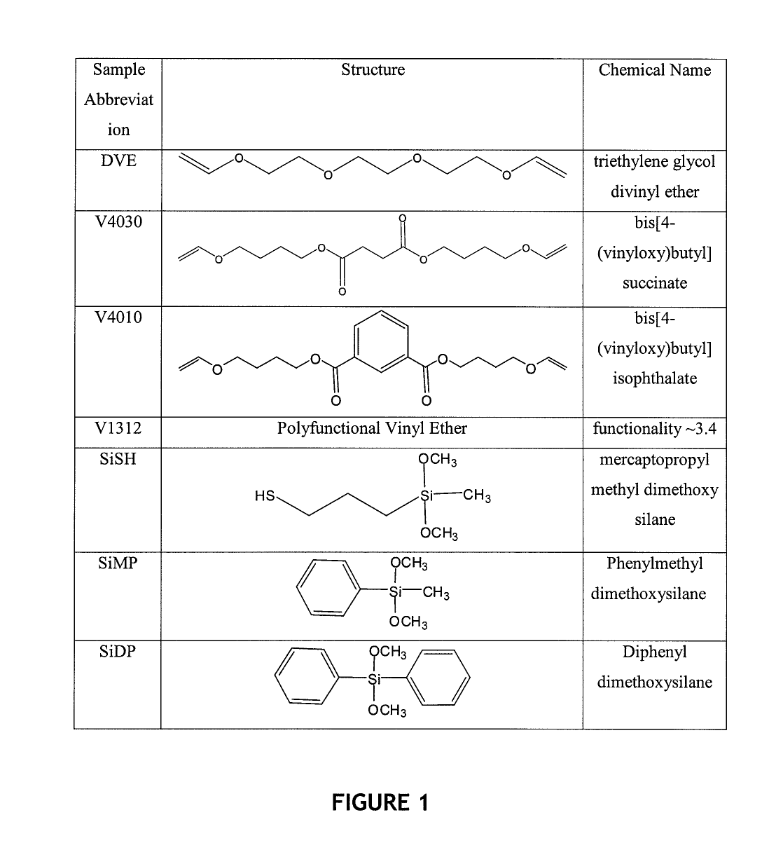

In one aspect, the vinyl monomer is a polysiloxane-based vinyl monomer. A “polysiloxane-based vinyl monomer” includes any monomer having a discrete chemical formula and having one or more vinyl functional groups, or a reactive oligomer, or reactive polymer, or pre-polymer, having at least one, but preferably two or more vinyl groups attached to a polysiloxane backbone. The polysiloxane-based vinyl monomer may be synthesized utilizing vinylsilanes by methods known in the art, or in a similar fashion to that described in Example 1. Appropriate vinylsilanes include, for example, 2-(dimethylvinylsilyl)pyridine, dimethoxymethylvinylsilane, diethoxy(methyl)vinylsilane (Sigma-Aldrich, Milwaukee, Wis.), alone, or in combination with other dialkoxysilanes such as dimethoxydimethylsilane, diethoxydimethylsilane, diphenyldimethoxysilane, phenylmethyldimethoxy silane and diethoxydiethylsilane, or the like. In another aspect, the vinyl monomer is a vinyl ether. Vinyl ether monomers suitable for embodiments of the present invention include any monomer having a discrete chemical formula and having one or more vinyl functional groups and one or more ether functional groups, i.e. “—CH₂—O—CH₂—”. The vinyl groups may be provided by, for example, allyls, allyl ethers, vinyl ethers, acrylates, methacrylates or other monomers containing vinyl groups. In one embodiment, vinyl ether monomers suitable for the present invention have at least two vinyl functional groups. Several polyvinyl monomers suited for use in the present disclosure are commercially available. In one aspect, trimethylolpropane diallyl ether, poly(ethylene glycol)divinyl ether, triethylene glycol divinyl ether (DVE), trimethylolpropane trivinyl ether, and pentaerythritol triallyl ether are available from Sigma-Aldrich (Milwaukee, Wis.) and are suitable for use as vinyl monomers. In another aspect, VEctomer® (Morflex, Greensboro, N.C.) sells polyvinyl monomers including multifunctional polyester vinyl ether (VE 1312), bis[4-(vinyloxy)butyl] isophthalate (VE 4010), bis[4-(vinyloxy)butyl] succinate (V 4030), bis [[4-(ethenyloxy)methyl] cyclohexyl]methyl] terephthalate (VE 4051), bis-(4-vinyl oxy butyl) adipate (VE 4060), bis-(4-vinyl oxy butyl)hexamethylenediurethane (VE 4230) and Tris(4-vinyloxybutyl)trimellitate (VE 5015). In a specific aspect, one or more of triethylene glycol divinyl ether (DVE), bis[4-(vinyloxy)butyl] isophthalate (Vectomer 4010), bis[4-(vinyloxy)butyl] succinate (Vectomer 4030), and multifunctional polyester vinyl ether (Vectomer 1312) are suitable for use as ene (vinyl ether) monomers. Certain of these are illustrated in FIG. 1.

In one embodiment, the impression materials are pure thiol-ene polysiloxane oligomers. However, the impression materials need not be pure thiol-ene polysiloxane oligomers and could include some amount of one or more other monomers. In one embodiment, one or more methacrylate monomers may be added to form the impression material. Unless otherwise specified or implied, the term “(meth)acrylate” or “methacrylate” includes both the methacrylate and the analogous acrylate.

In one embodiment, the optional methacrylate monomer is a dimethacrylate monomer. As used herein, a “dimethacrylate monomer” is a monomer having two polymerizable double bonds per molecule. Examples of suitable dimethacrylate monomers include: ethylene glycoldi(meth)acrylate, tetraethyleneglycoldi(meth)acrylate (TEGDMA), poly(ethylene glycol) dimethacrylates, the condensation product of bisphenol A and glycidyl methacrylate, 2,2′-bis[4-(3-methacryloxy-2-hydroxy propoxy)-phenyl] propane (bis-GMA), hexanediol di(meth)acrylate, tripropylene glycol di(meth)acrylate, butanediol di(meth)acrylate, neopentyl glycol di(meth)acrylate, diethylene glycol di(meth) acrylate, triethylene glycol di(meth)acrylate, dipropylene glycol di(meth)acrylate, allyl (meth)acrylate and derivatives thereof.

In one aspect, the optional methacrylate monomer is a dimer acid-derived methacrylate. Synthesis and characterization of suitable dimer-acid derived methacrylates are described in Stansbury et al. WO2005/107626, which is incorporated herein by reference. In a specific embodiment, the dimer-acid derived methacrylate is 2,2′-(8,8′-(3-heptyl-4-pentylcyclohexane-1,2-diyl)bis(octane-8,1-diyl))bis(azanediyl) bis(oxomethylene)bis(oxy)bis(ethane-2,1-diyl)bis(2-methylacrylate). The optional methacrylate can be added to the impression material in any weight percent. In one aspect, the optional methacrylate can be added in the amount of about 5 to 50 wt % of the weight of the impression material.

In one embodiment, the impression material compositions of the present disclosure comprising thiol-ene polysiloxane oligomer compositions may also include and/or utilize various initiators, fillers, accelerators, flavorants or sweeteners.

In one embodiment the thiol-ene free radical initiated photopolymerization may be photoinitiated by any range within the ultraviolet (about 200 to about 400 nm) and/or visible light spectrum (about 380 to about 780 nm). The choice of the wavelength range can be determined by the photoinitiator employed. In one aspect, a full spectrum light source, such as any dental operating light, e.g. a quartz-halogen xenon bulb, may be utilized for photopolymerization. In another aspect, a wavelength range of about 320 to about 500 nm is employed for photopolymerization.

In one embodiment, the impression materials optionally comprise a polymerization photoinitiator. Any radical photoinitiator may be employed. For example, if photopolymerization using visible light is desired, camphorquinone (CQ) and ethyl 4-dimethylaminobenzoate (EDAB), both available from Sigma-Aldrich (Milwaukee, Wis.) may be used as an initiator. Alternatively, if ultraviolet photopolymerization is desired, then 2,2-dimethoxy-2-phenylacetophenone (DMPA), Ciba-Geigy, Hawthorn, N.J.) may be used as an initiator. Photoinitiators can be used in amounts ranging from about 0.01 to about 5 weight percent (wt %). In one specific embodiment, 0.3 wt % CQ is used as an initiator for visible light experiments, along with 0.8 wt % ethyl 4-(dimethylamino)benzoate (commonly known as EDMAB or EDAB). In another specific embodiment, 0.2 wt % DMPA is used as an initiator for UV polymerization. One aspect of the thiol-ene system is that it can be readily initiated by just DMPA or camphorquinone, without the presence of the amine accelerator.

In one embodiment, amine accelerators may also be used, as well as other accelerators. Amine accelerators may be used as polymerization accelerators, as well as other accelerators. Polymerization accelerators suitable for use are the various organic tertiary amines well known in the art. In visible light curable compositions, the tertiary amines are generally acrylate derivatives such as dimethylaminoethyl methacrylate and, particularly, diethylaminoethyl methacrylate (DEAEMA), EDAB and the like, in an amount of about 0.05 to about 0.5 wt %. The tertiary amines are generally aromatic tertiary amines, preferably tertiary aromatic amines such as EDAB, 2-[4-(dimethylamino)phenyl]ethanol, N,N-dimethyl-p-toluidine (commonly abbreviated DMPT), bis(hydroxyethyl)-p-toluidine, triethanolamine, and the like. Such accelerators are generally present at about 0.5 to about 4.0 wt % in the polymeric component. In a preferred embodiment, 0.8 wt % EDAB is used in visible light polymerization. Certain embodiments of the thiol-ene system can be readily initiated by camphorquinone alone, without the presence of the amine accelerator. This is largely beneficial to the biocompatibility of photo-cured dental composites since studies have shown that certain tertiary amine accelerators, such as N,N-dimethyl-p-toluidine, are carcinogenic and mutagenic.

The impression material compositions may optionally comprise one or more fillers. In one embodiment, fillers are used to increase the viscosity of the dental impression material, to tailor the hydrophilicity of the dental impression material, and to increase the stiffness (rubbery modulus) of the cured impression. The filled compositions can include one or more of the inorganic fillers currently used in dental restorative materials, the amount of such filler being determined by the specific function of the filled materials. Thus, for example, in one aspect dental impression materials may be mixed with 0 to 25% by weight (wt %) silanized filler compounds such as barium, strontium, zirconia silicate and/or amorphous silica to match the color and opacity to a particular use or tooth. The filler is typically in the form of particles with a size ranging from 0.01 to 5.0 micrometers. In one aspect, the filler is a hydrophobic fumed silica. In one specific aspect, the hydrophobic fumed silica filler is composed of nanoparticles or nanoclusters. A nanoparticle is defined as any particle less than 100 nanometers (nm) in diameter. A nanocluster is an agglomeration of nanoparticles. In one aspect, utilization of nanoclusters in a nanosized filler can be exploited to increase the load and improve some mechanical properties. In a specific aspect, the filler comprises 10% hydrophobic fumed silica nanoparticles, e.g. Aerosil R972, is utilized in the impression material. Aerosil R972 is a fumed silica aftertreated with dimethyldichlorosilane with an average primary particle size of 16 nm. In an alternative aspect, the filler is a hydrophilic fumed silica. Other suitable fillers are known in the art, and include those that are capable of being covalently bonded to the impression material itself or to a coupling agent that is covalently bonded to both. Examples of suitable filling materials include but are not limited to, silica, silicate glass, quartz, barium silicate, strontium silicate, barium borosilicate, strontium borosilicate, borosilicate, lithium silicate, lithium alumina silicate, amorphous silica, ammoniated or deammoniated calcium phosphate and alumina, zirconia, tin oxide, and titania. In one aspect, suitable fillers are those having a particle size in the range from about 0.01 to about 5.0 micrometers, mixed with a silicate colloid of about 0.001 to about 0.07 micrometers. Some of the aforementioned inorganic filling materials and methods of preparation thereof are disclosed in U.S. Pat. No. 4,544,359 and U.S. Pat. No. 4,547,531, pertinent portions of which are incorporated herein by reference. The above described filler materials may be combined with a variety of composite forming materials to produce high strength along with other beneficial physical and chemical properties.

The impression material compositions of this invention may optionally comprise a flavorant. In one aspect, flavorants are used to increase patient acceptability. Suitable flavorants include both natural and artificial flavors and mints, such as oil of peppermint, menthol, oil of spearmint, vanilla, oil of cinnamon, oil of wintergreen (methyl salicylate), and various fruit flavors, including but not limited to lemon oil, orange oil, grape flavor, lime oil, grapefruit oil, apple, apricot essence, and combinations thereof. The flavorings are generally utilized in amounts that will vary depending upon the individual flavor. Optionally, a small amount of a vegetable oil or equivalent material can be added to the flavor oil when it is desired to lessen any overly strong impact of the flavor. The flavorants are generally utilized in amounts that will vary depending upon the individual flavor, and may, for example range in amounts of 0.01% to about 3% by weight of the final composition product. The use of a flavorant is intended to increase the acceptability of the impression material composition to the patient.

The impression material compositions may optionally include a sweetener component which may comprise any one or more intense sweeteners known in the art. In one aspect, sweeteners are used to increase patient acceptability. Sweeteners may be chosen from the following non-limiting list, which includes saccharin and its various salts such as the sodium or calcium salt; cyclamic acid and its various salts such as sodium salt; free aspartame; dihydrochalcone sweetening compounds; glycyrrhizin; Stevia rebaudiana (Stevioside); monellin, thaumatin, and 1,6-dichloro-1,6-dideoxy,beta.-D-fructofuranosyl-4-chloro-4-deoxy-d-D-galactopyranoside (Sucralose). Also contemplated as a sweetener is the sugar substitute 3,6-dihydro-6-methyl-1-1,2,3-oxathiazin-4-one-2,2-dioxide, particularly the potassium (Acesulfame-K), sodium and calcium salts thereof as described in German Patent No. 2,001,017.7. As indicated, products within the scope of the present invention may include no sweetener at all. If sweetener is included, the amount of sweetener is effective to provide the desired degree of sweetness, generally 0.001 to 0.5 wt. % of the final product.

In one embodiment, the impression material of the present disclosure comprising thiol-ene polysiloxane oligomer compositions comprise from about 20 to about 80 wt % vinyl ether and from about 20 to 80 wt % polysiloxane-based thiol monomer. In one aspect, the impression material of the present invention may optionally contain from about 0% to 50% of a dimer acid-derived methacrylate. In yet another aspect, the impression material may contain from about 0% to about 25% of a filler. In one specific embodiment, the impression material comprises about 35% V4010 and about 65 wt % SiSH DP. In another specific embodiment, the impression material comprises about 32 wt % V4030 and about 68 wt % SiSH DP. In another specific embodiment, the impression material comprises about 39 wt % V4030, 41 wt % SiSH and 20 wt % dimer acid-derived methacrylate. In a further specific embodiment, about 0.2 wt % of a photoinitiator is added to the impression material. In another specific embodiment, about 10 wt % of a filler is added to the impression material.

In one embodiment, the impression material is prepared by mixing the polysiloxane-based thiol monomer with the vinylether and any optional components to homogeneity while protecting from photopolymerizing light. After mixing to homogeneity, the impression material may optionally be packaged into, for example, a light protective storage tube and sealed for storage at room temperature. The packaged impression material described herein is shipped as a single component that can be molded or receive an impression and be photopolymerized at the point of use. Until photopolymerized, the impression material can be used and adjusted as needed.

Dental impression compositions of the disclosure are analyzed to determine physical characteristics both prior to, and after, cure by photopolymerization. Polymerization kinetics, water contact angle, glass transition temperature, rubbery modulus, elasticity, and hysteresis are measured to evaluate properties of the impression materials.

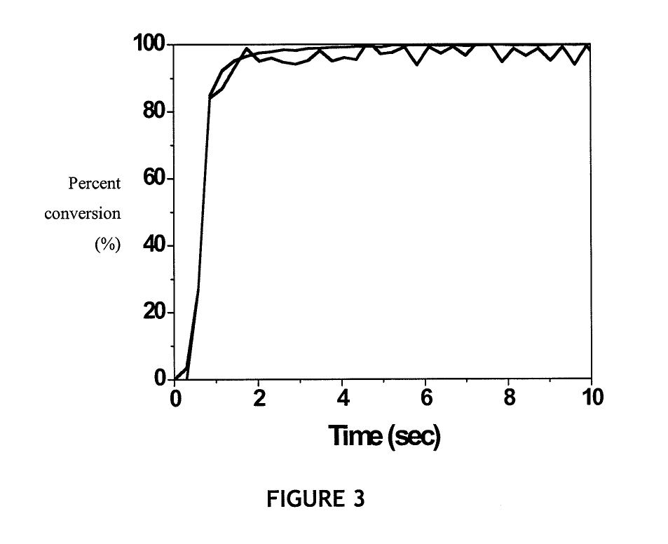

Polymerization kinetics can be determined by monitoring of conversion of functional groups. Conversion is defined as the loss of thiol or vinyl functional groups upon polymerization. Specifically, upon polymerization, the double-bond of the vinyl group (-ene, —CH═CH₂) is converted to a saturated ethane (-ane, —CH₂—CH₂—). The conversion of thiol (—SH) groups to thiol ethers (—S—CH₂—) occurs upon polymerization. Polymerization kinetics of thiol-ene systems may be monitored by Infrared spectroscopy (IR). Fourier Transform IR (FTIR) (e.g. Magna 750, Nicolet Instrument Corp., Madison, Wis.) may used to study the polymerization kinetics of the thiol-ene materials because of its inherent advantage of being able to measure the thiol and vinyl conversions simultaneously and rapidly as described in Cramer et al., J. Polymer Sci., Part A Polymer Chem., 39: 3311-3319 (2001), which is incorporated herein by reference. For example, the infrared peak absorbance at 1643 cm⁻¹ may be used for determining the allyl group conversion; the peaks at 1619 and 1636 cm⁻¹ for vinyl ethers; and the peak at 2572 cm⁻¹ may be used for the thiol group conversion. Conversions may be calculated with the ratio of peak areas to the peak area prior to polymerization. In one embodiment, the impression materials of the disclosure cure, or complete polymerization, more rapidly than commercially available polyether or VPS materials. In one aspect, the thiol-ene impression materials cure within about 60 seconds upon photopolymerization. In another aspect, the impression materials cure within about 30 seconds upon photopolymerization. Examples of cure kinetics for V4030/SiSH, V4030/SiSH MP/methacrylate(dimer acid), and V4030/SiSH DP/methacrylate(dimer acid) systems are given in FIGS. 3 (a), (b), and (c), respectively. In the embodiment shown, the dimer acid-derived methacrylate was 2,2′-(8,8′-(3-heptyl-4-pentylcyclohexane-1,2-diyl)bis(octane-8,1-diyl))bis(azanediyl) bis(oxomethylene)bis(oxy)bis(ethane-2,1-diyl)bis(2-methylacrylate). In addition to conversion kinetics, multiple material mechanical property measurements can be conducted.

Dynamic mechanical analysis (DMA) measures the mechanical properties of materials as a function of time, temperature and frequency. Stress is a measure of the average amount of force exerted per unit area. Strain is the deformation of a physical body under the action of applied forces. The modulus is considered the change in stress divided by the change in strain of a loaded material specimen within its elastic (non-yielded) range. For example, the modulus is proportional to force divided by the change in length. The modulus can be considered a measure of a material's stiffness. During heating a large loss of modulus occurs over the glass transition region. Material over the Tg is “rubbery”. The modulus of the rubbery material is directly related to the crosslink density. Components of material stiffness are separated into a complex modulus and a rubbery modulus. Flexibility (rubbery modulus) is an important property of impression materials because flexible impressions are easier to remove from the mouth when set. Impression materials of the present disclosure are optimally not brittle so that they will flex without crumbling.

Samples for dynamic mechanical analysis (DMA) may be tested on, for instance, a Q800, TA Instruments (Newcastle, Del.). DMA studies can be conducted over a temperature range of, for example, −50 to 120° C., with a ramping rate of 5° C./min using extension mode (sinusoidal stress of 1 Hz frequency) and the loss tangent peak can be monitored as a function of temperature. The loss tangent is defined as the polymer's loss modulus divided by storage modulus. During a DMA test, loss tangent peak corresponds to the viscoelastic relaxation of polymer chain or segments. The glass transition temperature can be determined by the maximum of the loss tangent versus the temperature curve. Normally, the largest loss tangent peak can be associated with the polymer's glass transition peak and the temperature of the loss tangent peak maximum can be used to define glass transition temperature (T_{g}).

The glass transition temperature (“Tg”) is the point where a substance changes from a hard-glassy material, to a soft-rubbery one. In monomer or thermoplastic polymers, the transition is from a solid or glass to a flowable liquid. For crosslinked thermosetting polymers, the transition is to a soft-rubbery composition and tends to occur across a thermal band rather than at a distinct point of temperature. At the glass transition temperature, several easily measurable properties such as volume, dimension, enthalpy, strength and modulus also undergo transitions, and are often used to determine Tg's. The Tg is determined predominantly by the backbone structure of the polymer. A high aromatic content results in a high Tg, while a high aliphatic content results in a lower Tg. Therefore, the impression materials for this invention can be tailored to exhibit a broad range of glass transition temperatures (T_{g}), depending on the monomer structures.

The term elasticity is defined as the ability of a material to return to its original shape and size after being stretched. A material is said to be elastic if it deforms under stress (e.g., external forces), but then returns to its original shape when the stress is removed. A set impression must be sufficiently elastic so that it will return to its original dimensions without significant distortion upon removal from the mouth. The Elastic Recovery Test can also be performed using ANSI/ADA Specification No. 19. This test measures the ability of a set impression material to recover its original dimensions after being deformed a specific distance.

The term water contact angle refers to the angle of contact between a drop of water and the surface of interest as a measure of the tendency for the water to spread over or wet the solid surface. The lower the contact angle, the greater the tendency for the water to wet the solid, until complete wetting occurs at an angle of zero degrees. The water contact angle can be used as a measure of hydrophilicity (see W. Noll, Chemistry and Technology of Silicones, Academic Press, NY, 1968, pp 447-452). The water contact angle can be determined by use of a contact angle goniometer.

A material exhibiting a water contact angle value of greater than 90° is considered hydrophobic. Unmodified polysiloxane surfaces are considered hydrophobic which makes reproduction of hard and soft oral tissue difficult since the oral cavity environment is wet and often contaminated with saliva or blood. Commercially available VPS hydrophilic dental impression materials yield equilibrium values in the range of 40-60° when cured; however, the initial contact angle is much higher. For example, Extrude® MPV exhibits a contact angle of about 79° within 5 seconds; and a water contact angle of about 42° at 30 seconds. In one aspect of the disclosure, the polysiloxane-based thiol impression materials exhibit comparable or enhanced initial hydrophilicity (same or lower initial water contact angle) in order to get accurate impressions. In another aspect, the polysiloxane-based thiol impression materials exhibit decreased hydrophilicity (higher contact angle) after cure, when compared to commercially available VPS materials, in order to make removal from the mouth of the cured impression easier.

In conventional impression techniques, good initial hydrophilicity, can be considered important so that the material flows and favors moist surfaces during syringing and seating the tray in order to significantly enhance impression accuracy. In one aspect, the initial water contact angle of the impression material is less than 90°. After cure, however, hydrophilic materials are more difficult to remove from the mouth. After cure of the impression material, an increased contact angle, or decreased hydrophilicity, is a desired property of the impression material. Therefore, it is important to be able to tailor the hydrophilicity of the impression material to obtain the best possible detail in the most reproducible fashion. In one aspect, the contact angle after cure is greater than the contact angle of commercially available VPS materials such as Extrude® MPV, such that the cured impression material is easy to remove from the mouth after cure.

One method of obtaining the water contact angle is the sessile drop method which is measured by a contact angle goniometer using an optical subsystem to capture the profile of water on the preset polymer. The angle formed between the liquid/solid interface and the liquid/vapor interface is the contact angle. Older systems used a microscope optical system with a back light. Current-generation systems employ high resolutions cameras and software to capture and analyze the contact angle. A contact angle goniometer system may be custom built, or may be purchased commercially. For example, a Cam200 Contact Angle Meter, KSV modular digital camera and software, (Monroe, Conn.), can be used to obtain the contact angle.

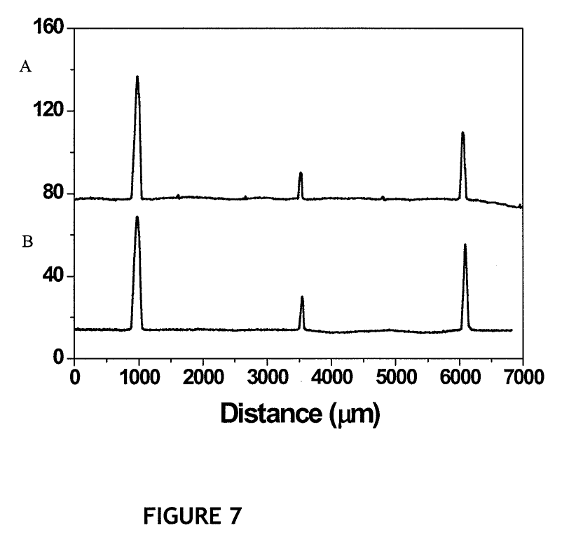

Detail reproduction of dental impression materials is primary importance. The presence of moisture has been shown to lead to less detail in elastomeric impressions (Johnson et al., J. Prosthet. Dent., 2003; 90:354-364). Therefore, the ability to tailor the hydrophilicity of the preset impression material is one factor in detail reproduction. Detail reproduction is also dependent of the ability of the impression material to displace moisture from the oral surface. The significance of moisture displacement in clinical practice depends on the level of contamination present on the tooth and surrounding tissues during the time of the making of the impression. Where moisture is unavoidable, it is important that the impression material have the ability to displace the contaminating moisture. In one aspect, impression materials of the disclosure provide good detail reproduction. In a specific aspect, detail reproduction of V4030 SiSH DP filled with 10 wt % R972 was equivalent to the standard sample of Extrude® MPV, as shown in FIG. 7. Detail reproduction can also be determined by, for example, as described in the American National Standards Institute/American Dental Association ANSI/ADA Specification No. 19, Dental Elastomeric Impression Materials. Chicago:ADA. This test is meant to indicate the ability of the elastomeric impression material to provide a detailed negative copy of the surface being impressed.

The Tear Strength test can be performed as described in ADA Professional Product Review Elastomeric Impression materials:Laboratory Testing Methods. Vol. 2, Issue 3, Summer 2007 (online) at www.ada.org/goto/ppr. This test provides quantitative information on the ability of an impression material to resist tearing when being “snapped” from the mouth. In one aspect, the impression materials of the invention offer good tear strength when compared to commercially available VPS and polyether impression materials.

The Linear Dimensional Change Test with and without Disinfection can also be performed by a protocol also from ANSI/ADA Spec. No. 19 or International Organization for Standardization. ISO 4823:2000, Dentistry-Elastomeric Impression Materials. Geneva: ISO.

The dimensional stability of the impression material after it is removed from the mouth is important for obtaining an accurate impression. Factors affecting this stability include the coefficient of thermal expansion of the material due to the change in temperature from the moth to room temperature, polymerization shrinkage, and loss of volatile components. Exposure to water, disinfection medium and high humidity environments can also affect dimensional stability of the impression material. The linear dimension change test is meant to measure the cumulative effect of these factors on the dimensional stability of the impression material.

The Strain-in-Compression Test can also be performed using ANSI/ADA Specification No. 19. This test measures “method of measuring the flexibility/stiffness property ranges of materials so to determine whether the set material, when formed as impressions, 1) can be removed from the mouth without injury to impressed oral tissues, and 2) will have adequate stiffness, in the more flexible portions of impressions, to resist deformation when model-forming products are poured against them.” Besides a maximum, there is a minimum strain-in-compression that is stated in the specification because if the impression material is too stiff upon setting it could damage oral tissues upon removal.

In one embodiment, the impression material may be packaged into and shipped in containers such as dispensing tubes, tubs, syringes or cans. The containers may be bulk containers or single use containers. If provided in a syringe, the user dispenses (by pressing a plunger or turning a screw adapted plunger on the syringe) the necessary amount of restorative material from the syringe onto a tray. The impression material may be shipped in a kit with separate transparent trays for use when creating the impression, thus obviating the need for the user to provide their own trays and to dispense the impression material. In one embodiment, the impression material is pre-loaded into the transparent impression tray which is packaged in a light and air impermeable pouch. In another embodiment, the packaged impression material has a good shelf life. In one aspect, the shelf life of the sealed packaged impression material is 24 months at ambient temperature.

In one embodiment, the impression material may be used by removing an amount of the impression material from a container. In this embodiment, the impression material is a single component dental impression material. Because of the properties of the impression material, embodiments may not need to be prepared, mixed or otherwise manipulated prior to application to the object of which the impression is to be made. This is one advantage to including polysiloxane oligomers that are functionalized with thiol or vinyl functional groups in the impression material. The impression material is then applied to the object from which the impression is to be obtained, e.g., a tooth. This may include dispensing or placing an amount of the impression material in a mold tray or some other device. When used, impression materials, in the fluid or plastic state, may be carried to the mouth in a suitably sized tray. Alternately, a broken or removed tooth may be brought to the tray. The trays may be made of a material that assists in the photopolymerization of the impression material, e.g., by being transparent to the light used to photopolymerize the material. Transparent dental impression trays are described in, for example, Wang, U.S. Pat. No. 4,553,936, expired and Hammesfahr et al., U.S. Pat. No. 4,867,682, expired; each of which is incorporated herein by reference. The impression is then made in the impression material so that the impression has the desired shape of the object. For artificial teeth, this may include forcing the mold tray onto a tooth or teeth of a patient at a dentist's office. The impression material is then photopolymerized. In one embodiment, the polymerization may be performed while the object/tooth is within the impression material. Properties of the impression material are sufficiently elastic to allow the polymerized impression material to be removed from the teeth without damaging the set impression made during polymerization. The polymerized impression material may then be used as a mold for the creation of a copy of the impressed object. In embodiments for making an artificial tooth or teeth, an artificial tooth compound as are known in the art may be placed into the set impression and solidified. Note that the artificial tooth may then be removed without damaging the mold and, thus, the mold may be reused at a future date.

Various photopolymerization cure conditions may be employed with use of the thiol-ene polysiloxane impression materials of the present disclosure. For example, in one specific embodiment, light in the range of 320 to 500 nm wavelength, at an intensity of 15 mW/cm² is utilized with a 0.2 wt % of DMPA in the impression material. In one aspect, the thiol-ene polysiloxane impression materials cure within 10 seconds, and the thiol-vinyl ether-methacrylate mixtures cure within 30 seconds, upon UV irradiation.

In one embodiment, the disclosure provides a method for making a dental impression mold comprising the steps of exposing an area for implant; applying and positioning a photochemically curable impression material comprising a polysiloxane-based thiol monomer to said exposed area; applying sufficient pressure to seat and mold the impression material at the desired position in a desired size and shape; and curing the elastomeric material using a light source to form the dental impression mold. The resulting cured polymer may then be finished or polished as necessary with appropriate tools.

In another embodiment, the disclosure provides a method of making an artificial tooth, the method comprising removing an amount of an impression material from a container, the impression material including polysiloxane oligomers that are functionalized with thiol and vinyl functional groups; placing an amount of impression material in a mold tray; making an impression in the impression material, the impression having the desired shape of the artificial tooth; photopolymerizing the impression material to create a mold including a set impression of the artificial tooth; and creating at least one artificial tooth from the mold by placing an artificial tooth compound into the set impression and solidifying the artificial tooth compound.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Those skilled in the art will recognize that the methods and systems of the present disclosure may be implemented in many manners and as such are not to be limited by the foregoing exemplary embodiments and examples. While various embodiments have been described, various changes and modifications may be made which are well within the scope of the present disclosure. For example, where feasible any of the method steps or operations may be performed in different orders than those discussed above, as long as the ultimate result of a usable set impression can be obtained.

Numerous other changes may be made which will readily suggest themselves to those skilled in the art and which are encompassed in the spirit of the disclosure and as defined in the appended claims. Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

### EXAMPLES

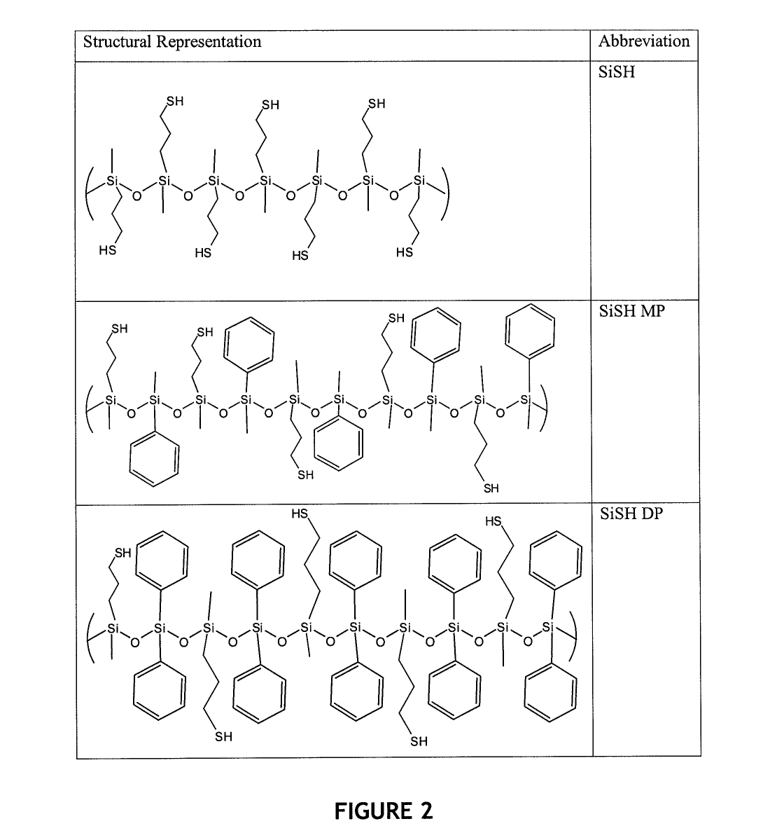

Example impression materials for this invention were produced from thiol-ene mixtures of different polysiloxane-based thiol and vinyl ether monomers shown in FIGS. 1 and 2. Mercaptopropyl methyldimethoxy silane (SiSH), diphenyldimethoxysilane (SiDP), phenylmethyldimethoxy silane (SiMP), and dimethyldimethoxysilane (SiDM) were used for synthesis of polysiloxane-based multifunctional thiol oligomers. Triethylene glycol divinyl ether (DVE), bis[4-(vinyloxy)butyl] isophthalate (Vectomer 4010), bis[4-(vinyloxy)butyl] succinate (Vectomer 4030), and multifunctional polyester vinyl ether (Vectomer 1312) (Sigma-Aldrich, Milwaukee, Wis.) were used as ene (vinyl ether) monomers. Irgacure 651 (DMPA) was used as the initiating system. All chemicals were used as received.

Samples can be irradiated with, for example, an EFOS Ultracure with a 320-500 nm bandpass filter. Irradiation intensity was measured at the surface level with an International Light Inc. Model IL400A radiometer (Newbury, Mass.).

The cure rates and final double bond conversion can be measured using real-time FTIR spectroscopy. For example, FTIR experiments can be conducted in the mid-infrared range (4000-600 cm⁻¹) using a Nicolet 750 Magna FTIR Spectrometer (Madison, Wis.) with a KBr beam splitter and an MCT/A detector. Samples can be laminated between NaCl windows and a horizontal transmission accessory (HTA) can be utilized to redirect the IR beam vertically which allows the samples to remain in the horizontal position during analysis. The infrared peak absorbance at 1643 cm⁻¹ can be used for determining the allyl group conversion; the peaks at 1619 and 1636 cm⁻¹ for vinyl ethers; and the peak at 2572 cm⁻¹ can be used for the thiol group conversion. Conversions can be calculated with the ratio of peak areas to the peak area prior to polymerization.

The glass transition temperature and modulus of the polymers can be measured using dynamic mechanical analysis. Samples for dynamic mechanical analysis (DMA) can be tested on, for instance, a Q800, TA Instruments (Newcastle, Del.). DMA studies can be conducted over a temperature range of, for example, −50 to 120° C., with a ramping rate of 5° C./min using extension mode (sinusoidal stress of 1 Hz frequency) and the loss tangent peak can be monitored as a function of temperature. The loss tangent is defined as the polymer's loss modulus divided by storage modulus. During a DMA test, loss tangent peak corresponds to the viscoelastic relaxation of polymer chain or segments. The glass transition temperature can be determined by the maximum of the loss tangent versus the temperature curve.

The water contact angle was determined by use of a custom built contact angle goniometer. Contact angle measurements were made using static drops of deionized water. Initial contact angles were read at less than 5 seconds and pseudo-equilibrium contact angles were read at thirty seconds after contact of the drop with the elastomer surface in the unset stage. Pseudo-equilibrium contact angles involve a time delay from surface contact to measurement to allow for the early rapid changes in contact angle which occur for some materials. The delay may be as long as 120 sec for some materials which undergo several “step-function” changes in contact angle as the equilibrium angle is approached. For the materials tested, 30 sec was adequate to yield stable readings.

### Example 1

### Synthesis of Polysiloxane-Based Thiols

For the synthesis of polysiloxane-based thiols, mercaptopropyl methyldimethoxy silane (SiSH) (10 g) was mixed with an equivalent amount of acidified water (1 mol % of HCl). The mixture was stirred for 24 hours at room temperature. For copolymer synthesis, 1:1 molar mixtures of mercaptopropyl methyldimethoxy silane (SiSH) with either diphenyldimethoxysilane (SiDP) or phenylmethyldimethoxy silane (SiMP) were used. After the reaction, products were purified by evaporating methanol and water. FIG. 2 shows the chemical structures of the polysiloxane-based thiol monomers synthesized.

### Example 2

### Preparation of Thiol-Polysiloxane-Vinyl Ethers Impression Materials

Polysiloxane-based thiol monomers and vinyl ether monomers and DMPA were added to a 20 mL scintillation vial and stirred magnetically. The relative weight % used for each oligomerization are given in Table 1; 0.2 wt % DMPA was used in each sample. The prepared thiol-ene oligomers were stored unpurified and away from light sources at ambient conditions. Samples were irradiated with an EFOS Ultracure with a 320-500 nm bandpass filter. Irradiation intensity was measured at the surface level with an International Light Inc. Model IL400A radiometer (Newbury, Mass.). Conversion of the thiol and vinyl functional groups was monitored using FTIR (Magna 750, Nicolet Instrument Corp., Madison Wis.). A goniometer was used to assess water contact angle from the time the drop was placed on the impression material. DMA was performed on each sample. Table 1 exhibits final conversion, water contact angle, glass transition temperature, and rubbery modulus of the formulated samples.

TABLE 1
Final conversion, water contact angle, glass transition temperature, and
rubbery modulus of thiol-vinyl ether samples.

| | | | | | Contact | | | |
|---|---|---|---|---|---|---|---|---|
| | Content | Conversion (%)¹ | | | Angle | | | Rubbery |
| Sample | (wt %) | VE | SH | Meth | (°)² | | Tg (° C.) | Modulus |
| Extrude MVP | — | — | | | 78.6 | 42 | −26 | 4.3 |
| V1312/SiSH MP | 73/27 | 100 | 100 | — | 71.8 | 61.8 | −23 | 5.3 |
| V1312/SiSH DP | 52/48 | 100 | 100 | — | 60.2 | 52.4 | −18 | 4.3 |
| V1312/SiSH MP/ | 46/34/20 | 86 | — | 100 | 70.6 | 63 | −12 | 3.2 |
| Dimer 20 wt % | | | | | | | | |
| V4010/SiSH | 57/43 | 100 | 100 | — | 62.4 | 56.4 | −9 | 11 |
| V4010/SiSH MP | 40/60 | 100 | 100 | — | 68.2 | 58.4 | −13.5 | 2.2 |
| V4010/SiSH DP | 35/65 | 100 | 100 | — | 81.8 | 70.6 | 1.4 | 0.85 |
| V4010/SiSH MP/ | 41/39/20 | 91 | — | 100 | 72.2 | 62.4 | −8.8 | 2.3 |
| Dimer 20 wt % | | | | | | | | |
| V4010/SiSH DP/ | 37/23/40 | 64 | — | 100 | 69.8 | 60.8 | 6.55 | 2.6 |
| Dimer 40 wt % | | | | | | | | |
| V4030/SiSH | 54/46 | 100 | 100 | — | 61 | 52.2 | −31 | 10 |
| V4030/SiSH MP | 37/63 | 100 | 100 | — | 69.6 | 60 | −26 | 2 |
| V4030/SiSH DP | 32/68 | 100 | 100 | — | 82.4 | 70 | −13 | 0.57 |
| V4030/SiSH MP/ | 39/41/20 | 90 | — | 100 | 62 | 49.2 | −20 | 2.2 |
| Dimer 20 wt % | | | | | | | | |
| V4030/SiSH DP/ | 35/25/40 | 79 | — | 100 | 71.4 | 61.4 | −0.2 | 2.9 |
| Dimer 40 wt % | | | | | | | | |

¹Conversion; VE: vinyl ether, SH: thiol, and Meth: methacrylate functional groups
Polymerization condition; 320-500 nm, 15 mW/cm², 0.2 wt % DMPA
²Contact angle; A measured within 5 sec and B measured at 30 sec.

### Example 3

### Cure Kinetics

The cure rates and final double bond conversion were measured using real-time FTIR spectroscopy. FTIR experiments were conducted in the mid-infrared range (4000-600 cm⁻¹) using a Nicolet 750 Magna FTIR Spectrometer (Madison, Wis.) with a KBr beam splitter and an MCT/A detector. The infrared peak absorbance at 1619 and 1636 cm⁻¹ was used for determining vinyl ether conversion; and the peak at 2572 cm⁻¹ was used for the monitoring thiol group conversion. Conversions were calculated with the ratio of peak areas to the peak area prior to polymerization.

All thiol-ene mixtures were cured within 10 seconds, as shown in FIG. 3(a). The thiol-vinyl ether-methacrylate mixtures took up to 30 seconds to cure, upon UV irradiation, as shown in FIGS. 3 (b) and (c). Example of cure kinetics for V4030/SiSH, V4030/SiSH MP/methacrylate(dimer acid), and V4030/SiSH DP/methacrylate(dimer acid) systems are given in FIGS. 3 (a), (b), and (c), respectively. In the embodiment shown, the dimer acid-derived methacrylate was 2,2′-(8,8′-(3-heptyl-4-pentylcyclohexane-1,2-diyl)bis(octane-8,1-diyl))bis(azanediyl) bis(oxomethylene)bis(oxy)bis(ethane-2,1-diyl)bis(2-methylacrylate).

### Example 4

### Water Contact Angle

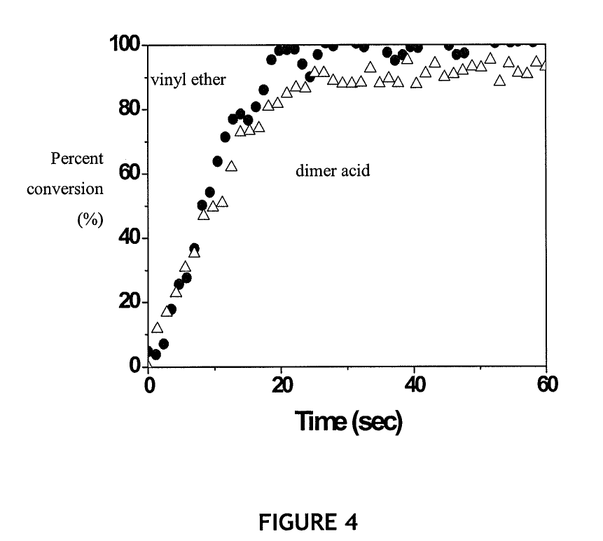

Water contact angles were taken for various unset samples using a contact angle goniometer at less than 5 and at 30 seconds of the placement of the drop. FIG. 4 shows the contact angles of V4030/SiSH, V4030/SiSH MP, and V4030/SiSH DP mixtures. Each sample has different polysiloxane content as shown in Table 1. The contact angle (°) is shown as a function of polysiloxane thiol content (wt %) of V4030/polysiloxane thiol mixtures. The values were measured within 5 seconds (□) and at 30 seconds (). Lines in figure represent values for the control sample (Extrude® MPV).

The water contact angle of the thiol-ene materials varies depending on the amount of polysiloxane-based thiol and the vinyl ether structure (Table 1). In general, with increasing content of hydrophobic polysiloxane thiol, water contact angle increases from 60° to 82°. The standard sample (Extrude® MPV) exhibits a water contact angle of approximately 78°. The contact angle significantly decreases with time (40° after 30 sec), indicating rapid wetting behavior. The samples used in this study do not contain fillers. The addition of hydrophilic fillers would increase sample wettability, if desired.

### Example 5

### Dynamic Mechanical Analysis

The impression materials for this invention are tailorable to exhibit a broad range of glass transition temperatures (T_{g}), depending on the monomer structures. The rigid phenyl groups of the polysiloxane thiol and vinyl ether monomers lead to increased T_{g}. Flexibility (rubbery modulus) is an important property of impression materials because flexible impressions are easier to remove from the mouth when set. The thiol-vinyl ether impression samples such as V4010 SiSH DP and V4030 SiSH DP show greater flexibility when compared to the control sample.

A set impression must be sufficiently elastic so that it will return to its original dimensions without significant distortion upon removal from the mouth. Given in Table 2 are the elongation at break and stress at break for the evaluated materials. The thiol-vinyl ether samples V4010 SiSH DP and V4030 SiSH DP show high elasticity and low hysteresis as compared to the standard sample. The stress is also much lower in these samples than the standard sample, which is expected from the low rubbery modulus shown in Table 1.

TABLE 2
Elastic recovery and mechanical properties of thiol-vinyl ether samples.

| | | | Stress | | | |
|---|---|---|---|---|---|---|
| | | | at 30% | | | |
| | Content | Elasticity | strain | Hysteresis | Elongation | Stress at |
| Sample | (wt %) | (%)* | (MPa)* | (%)* | at break (%) | break (MPa) |
| Extrude | — | 98.4 | 1.2 | 20.8 | — | — |
| MVP | | | | | | |
| V1312 | 73/27 | — | — | — | 16 | 0.63 |
| SiSH MP | | | | | | |
| V1312 | 46/34/20 | — | — | — | 14 | 0.47 |
| SiSH MP | | | | | | |
| Dimer 20 wt % | | | | | | |
| V1312 | 52/48 | — | — | — | 26 | 0.46 |
| SiSH DP | | | | | | |
| V4010 | 57/43 | — | — | — | 6 | 0.51 |
| SiSH | | | | | | |
| V4010 | 40/60 | — | — | — | 17 | 0.31 |
| SiSH MP | | | | | | |
| V4010 | 35/65 | 99.4 | 0.19 | 6.5 | — | — |
| SiSH DP | | | | | | |
| V4010 | 41/39/20 | — | — | — | 20 | 0.36 |
| SiSH MP | | | | | | |
| Dimer 20 wt % | | | | | | |
| V4010 | 37/23/40 | — | — | — | 25 | 0.54 |
| SiSH DP | | | | | | |
| Dimer 40 wt % | | | | | | |
| V4030 | 54/46 | — | — | — | 7 | 0.6 |
| SiSH | | | | | | |
| V4030 | 37/63 | — | — | — | 18 | 0.3 |
| SiSH MP | | | | | | |
| V4030 | 32/68 | 99.4 | 0.13 | 7.0 | — | — |
| SiSH DP | | | | | | |
| V4030 | 39/41/20 | — | — | — | 15 | 0.3 |
| SiSH MP | | | | | | |
| Dimer 20 wt % | | | | | | |
| V4030 | 35/25/40 | — | — | — | 21 | 0.45 |
| SiSH DP | | | | | | |
| Dimer 40 wt % | | | | | | |

*measured from deformation-relaxation process. Given strain is 30% (crosshead speed 50%/min). Polymerization condition; 320-500 nm, 15 mW/cm 2, 0.2 wt % DMPA

### Example 6

### Addition of Filler to the Impression Material

Hydrophobic silica nanoparticles (10 wt %, Aerosil R972) were mixed with V4010 SiSH DP and V4030 SiSH DP samples. Polymerization kinetics and mechanical properties were measured. As shown in Table 3, all samples achieved 100% conversion and polymerization rates are not decreased, indicating that the filler does not significantly affect the polymerization kinetics. The T_{g} is also not affected by the fillers as is generally observed in filled photocurable systems. The rubbery modulus increases significantly, 70% for V4010 SiSH DP and 23% for V4030 SiSH DP. The water contact angle is increased) (˜10° with the addition of only 10 wt % filler and this result indicates that modifying the surface chemistry of fillers can control wettability.

TABLE 3
Final conversion, water contact angle, the glass transition temperature, and
rubbery modulus of thiol-vinyl ether samples filled with 10 wt % R972.

| | | Filler | Conversion | | Contact | | | Rubbery |
|---|---|---|---|---|---|---|---|---|
| | Content | Content | (%)¹ | | Angle (o)² | | | Modulus |
| Sample | (wt %) | (wt %) | VE | SH | A | B | Tg (° C.) | (MPa) |
| Extrude | — | — | — | — | 78.6 | 42 | −26 | 4.3 |
| MVP | | | | | | | | |
| V4010/ | 35/65 | 0 | 100 | 100 | 81.8 | 70.6 | 1.4 | 0.85 |
| SiSH DP | | | | | | | | |
| V4010/ | 35/65 | 10 | 100 | 100 | 89.7 | 75.6 | 1.3 | 1.48 |
| SiSH DP | | | | | | | | |
| R972 10 wt % | | | | | | | | |
| V4030/ | 32/68 | 0 | 100 | 100 | 82.4 | 70 | −13 | 0.57 |
| SiSH DP | | | | | | | | |
| V4030/SiSH | 32/68 | 10 | 100 | 100 | 89.5 | 73.7 | −13 | 0.7 |
| DP R972 | | | | | | | | |
| 10 wt % | | | | | | | | |

¹Conversion; VE: vinyl ether, SH: thiol, and Meth: methacrylate functional groups
²Contact angle; A. measured within 5 sec and B. measured at 30 sec.
Polymerization condition; 320-500 nm, 15 mW/cm², 0.2 wt % DMPA.

The effect of fillers on the elasticity of thiol-ene impression materials is shown in Tables 4 and 5. It is clearly shown in Table 4 that fillers have very little effect on elasticity and hysteresis, with elasticity decreasing less than 1%. Even with fillers, elasticity and hysteresis are much better than the standard sample. As shown in Table 5, thiol-vinyl ether impression materials exhibit up to 9% higher elasticity and 45% lower hysteresis than the standard sample.

TABLE 4
Elastic recovery and mechanical properties of thiol-vinyl ether samples
filled with 10 wt % R972 (30% strain).

| | Polysiloxane | Filler | | Stress at | |
|---|---|---|---|---|---|
| | Thiol Content | Content | Elasticity | 30% strain | Hysteresis |
| Sample | (wt %) | (wt %) | (%)* | (MPa)* | (%)* |
| Extrude | — | — | 98.4 | 1.2 | 20.8 |
| MVP | | | | | |
| V4010 | 35/65 | 0 | 99.4 | 0.19 | 6.5 |
| SiSH DP | | | | | |
| V4010 | 35/65 | 10 | 98.9 | 0.32 | 10.8 |
| SiSH DP | | | | | |
| R972 | | | | | |
| 10 wt % | | | | | |
| V4010 | 32/68 | 10 | 99.4 | 0.13 | 7.0 |
| SiSH DP | | | | | |
| V4030 | 32/68 | 10 | 99.3 | 0.15 | 7.3 |
| SiSH DP | | | | | |
| R972 | | | | | |
| 10 wt % | | | | | |

*measured from deformation-relaxation process. Given strain is 30% (crosshead speed 50%/min)

TABLE 5
Elastic recovery and mechanical properties of thiol-vinyl ether samples
filled with 10 wt % R972 (50% strain).

| | Polysiloxane | | | | |
|---|---|---|---|---|---|
| | Thiol | Filler | | Stress at | |
| | Content | Content | Elasticity | 50% strain | Hysteresis |
| Sample | (wt %) | (wt %) | (%)* | (MPa)* | (%)* |
| Extrude | — | — | 89.7 | 1.58 | 58.1 |
| MVP | | | | | |
| V4010 | 35/65 | 10 | 95.6 | 0.52 | 22.8 |
| SiSH | | | | | |
| DP | | | | | |
| R972 | | | | | |
| 10 wt % | | | | | |
| V4030 | 32/68 | 10 | 98.2 | 0.26 | 13.5 |
| SiSH | | | | | |
| DP | | | | | |
| R972 | | | | | |
| 10 wt % | | | | | |

*measured from deformation-relaxation process. Given strain is 30% (crosshead speed 50%/min).

### Example 7

### Detail Reproduction

The line detail reproduction results of V4030 SiSH DP sample were compared to the standard sample of Extrude® MPV. Detail reproduction is measured using a mold containing three lines with different resolution. Replicas were produced using the standard sample and the V4030/SiSH DP/filler (10 wt %) sample and line reproduction was measured by a Profilometer. Three different reproduction lines with different thickness (75, 50, and 25 μm) are evident for both samples, indicating that thiol-vinyl ether impression materials have comparable detail reproduction capability to the standard sample. FIG. 7 shows stacked surface profiles of V4030 SiSH DP filled with 10 wt % R972 (top line) and the standard sample of Extrude® MPV. (bottom line). The Y-axis shows a height scale (μm) for stacked surface profiles.

We claim:

1. A method for making a dental impression mold comprising the steps of:
exposing an area for implant;
applying and positioning a photochemically curable impression material comprising a thiol monomer and a vinyl monomer to said exposed area;
applying sufficient pressure to seat and mold the impression material in a desired size and shape; and
curing the impression material using a light source to form the dental impression mold.

2. The method of claim 1 wherein the thiol monomer is selected from a polysiloxane-based thiol monomer, an alkyl thiol, a thiol glycolate ester, and a thiol propionate ester.

3. The method of claim 2 wherein the thiol monomer is a polysiloxane-based thiol monomer.

4. The method of claim 3 wherein the polysiloxane-based thiol monomer is formed from one or more silanes selected from mercaptopropyl methyl dimethoxysilane, phenylmethyldimethoxysilane, and diphenyldimethoxysilane.

5. The method of claim 1 wherein the vinyl monomer is selected from a vinyl ether, vinyl ester, allyl ether, acrylate, methacrylate, norbornene, diene, propenyl, alkene, alkyne, N-vinyl amide, unsaturated ester, acrylate, N-substituted maleimide, polysiloxane-based vinyl monomer and a styrene.

6. The method of claim 1 wherein the photochemically curable impression material further comprises one or more fillers.

7. The method of claim 6 wherein the one or more fillers are selected from silica, silicate glass, quartz, barium silicate, strontium silicate, barium borosilicate, strontium borosilicate, borosilicate, lithium silicate, lithium alumina silicate, amorphous silica, ammoniated or deammoniated calcium phosphate and alumina, zirconia, tin oxide, and titania.

8. The method of claim 6 wherein the total amount of the one or more fillers is from about 0 to about 25 wt % of the total weight of the dental impression material.

9. The method of claim 1, wherein the photochemically curable impression material further comprises one or more flavorants.

10. A dental impression material composition, the composition comprising a thiol monomer and a vinyl monomer.

11. The composition of claim 10 wherein the thiol monomer is selected from a polysiloxane-based thiol monomer, an alkyl thiol, a thiol glycolate ester, and a thiol propionate ester.

12. The composition of claim 11 wherein the thiol monomer is a polysiloxane-based thiol monomer.

13. The composition of claim 12 wherein the polysiloxane-based thiol monomer is prepared using one or more of mercaptopropyl methyl dimethoxysilane, (3-mercaptopropyl)methyl-methoxy-phenoxysilane, (3-mercaptopropyl)methyl-diphenoxysilane, (mercaptomethyl)methyldiethoxysilane, phenylmethyldimethoxysilane, and diphenyldimethoxysilane.

14. The composition of claim 10 wherein the vinyl monomer is selected from a vinyl ether, vinyl ester, allyl ether, acrylate, methacrylate, norbornene, diene, propenyl, alkene, alkyne, N-vinyl amide, unsaturated ester, acrylate, N-substituted maleimide, polysiloxane-based vinyl monomer and a styrene.

15. The composition of claim 14 wherein the vinyl monomer is a polysiloxane-based vinyl monomer.

16. The composition of claim 10 further comprising at least one photoinitiator.

17. The composition of claim 16 wherein the photoinitiator is 2,2-dimethoxy-2-phenylacetophenone.

18. The composition of claim 10 further comprising a methacrylate.

19. The composition of claim 10 further comprising one or more fillers.

20. The composition of claim 19 wherein the one or more fillers are selected from silica, silicate glass, quartz, barium silicate, strontium silicate, barium borosilicate, strontium borosilicate, borosilicate, lithium silicate, lithium alumina silicate, amorphous silica, ammoniated or deammoniated calcium phosphate and alumina, zirconia, tin oxide, and titania.

21. The composition of claim 20 wherein the filler is silica.

22. The composition of claim 21 wherein the silica is a hydrophobic silica in a form selected from nanoparticles and nanoclusters.

23. The composition of claim 10 further comprising one or more flavorants.

24. The composition of claim 23 wherein the one or more flavorants are selected from peppermint oil, menthol, cinnamon oil, spearmint oil, vanilla, wintergreen oil, lemon oil, orange oil, grape, lime oil, grapefruit oil, apple, apricot essence, and mixtures thereof.

25. A method of making an artificial tooth, the method comprising:
removing an amount of an impression material from a container, the impression material comprising a thiol monomer and a vinyl monomer;
placing an amount of impression material in a mold tray;
making an impression in the impression material, the impression having the desired shape of the artificial tooth;
photopolymerizing the impression material to create a mold including a set impression of the artificial tooth; and
creating at least one artificial tooth from the mold by placing an artificial tooth compound into the set impression and solidifying the artificial tooth compound.

26. The method of claim 25 wherein the thiol monomer is selected from a polysiloxane-based thiol monomer, an alkyl thiol, a thiol glycolate ester, and a thiol propionate ester.
